(19) United States
(12) Patent Application Publication
(10) Pub. No.: US 2007/0150555 A1
(43) Pub. Date: Jun. 28, 2007

(54) Method, Devices And System For Implementing A Time-Shift Television

(75) Inventors: Daiyi He, Shenzhen (CN); Bailiang Yang, Shenzhen (CN); Yi Li, Shenzhen (CN); Zhentao Yang, Shenzhen (CN); Shaojun Li, Shenzhen (CN); Yuan Liu, Shenzhen (CN); Yunsong Fan, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 11/565,088

(22) Filed: Nov. 30, 2006

(30) Foreign Application Priority Data
Nov. 30, 2005 (CN) 200510125845.4

(51) Int. Cl. G06F 15/16

(52) U.S. Cl. 709/219

(57) ABSTRACT

A method for controlling the data flow of the time-shift TV is disreleased and includes: establishing and holding a control channel between a playing terminal and a media server; transmitting a time-shift playing command to the media server by the playing terminal through the control channel; and upon receiving the time-shift playing command, performing a operation corresponding to the time-shift playing command by the media server. A playing terminal, a media server and a time-shift TV system are also disreleased. Using the control channel, the time-shift playing command can be transmitted to the media server and the time-shift player can transmit the time-shift data flow and the live data flow to the playing terminal, improving the speed of implementing the time-shift playing, providing better experiences for subscribers and being good for the development and application of the time-shift TV technique.

### CROSS-REFERENCE TO RELATED APPLICATIONS

This application claims the benefit of Chinese Patent Application No. 200510125845.4 filed Nov. 30, 2005. The disclosure of the above application is incorporated herein by reference.

### FIELD

The present disclosure relates to network multimedia technologies, and more particularly, to a method for implementing a time-shift television (TV) as well as devices and a system thereof.

### BACKGROUND

The statements in this section merely provide background information related to the present disclosure and may not constitute prior art.

The live TV, as a main TV technique in the existing broadcast TV system, generally provides unidirectional services for its subscribers. In such a case, the subscribers can do nothing with the schedule of TV programs but watch a fixed TV program at a designated time.

In order to improve service experiences for subscribers when watching TV, a time-shift TV technique emerges as required. A time-shift TV employs the time-shift TV technique to enable playback of live presentations for the subscribers by such time-shift control operations as fast scan reverse, pause, seeking and the like.

At an early stage of network techniques, a time-shift TV generally utilizes memory medium connected to a playing terminal to record and store live data flows to provide a time-shift service. When a playing terminal in a live mode receives a time-shift playing command initiated by a subscriber, it may record and store the live data flows while stop playing the live data flows, and read recorded time-shift data flows stored in the memory medium for playing according to the received time-shift playing command. Similarly, when a playing terminal in a time-shift mode receives a live playing command, it may also continue to record and store the live data flows while stop playing the time-shift version, and to play the received live data flows.

In accordance with the time-shift TV technique above, assume that the speed of playing the live data flows is 1.5 Mbps, the live data flows of only one channel recorded for 24 hours will need 16200 MB memory spaces, and thus the memory spaces needed for multiple channels are extremely huge. So the cost of storing all the live data flows by the playing terminal itself is very high. Moreover, when watching the time-shift TV programs, the live TV programs need receiving while the playing terminal needs to continuously record the live TV programs; otherwise the continuous time-shift playing could not be supported. In this case, tail-additional-write, head-partial-delete and read operations are made simultaneously to one recorded file, obviously decreasing the response speed of the time-shift operation and disabling better experiences for the subscribers.

As the development of network techniques, a time-shift TV generally utilizes a media server for recording the live data flows and a playing terminal for controlling the switching between the live data flows and the time-shift data flows to thereby implement time-shift functions. FIG. 1 shows a flowchart illustrating a method of switching the live mode to the time-shift mode. The method includes following steps.

Step 101: a playing terminal in a live mode receives a time-shift playing command and determines whether the current live programs are played in a unicast mode or in a multicast mode. If the unicast mode is used, Step 102 is performed; otherwise, Step 103 is performed.

Step 102: the playing terminal releases a live communication connection and a live data transmission channel between the playing terminal and a media server, exits the live mode, and goes to Step 104.

Step 103: the playing terminal directly exits the multicast group.

Step 104: the playing terminal establishes a time-shift communication connection to the media server according to the received time-shift playing command, negotiates with the media server to establish a time-shift data transmission channel with the media server, and reports the time-shift playing command to the media server through the time-shift communication connection.

Step 105: the media server reads time-shift data flows from a memory connected to the media server according to the received time-shift playing command, and transmits the read time-shift data flows to the playing terminal through the established time-shift data transmission channel.

Step 106: the playing terminal receives and plays the time-shift data flows from the media server. So far, switching from the live mode to the time-shift mode is implemented.

FIG. 2 shows a flowchart illustrating the method of switching the time-shift mode to the live mode, which includes the following steps.

Step 201: when receiving a live playing command, a playing terminal in the time-shift mode releases the time-shift communication connection and the time-shift data transmission channel related to the media server, and exits the time-shift mode.

Step 202: the playing terminal determines whether the unicast mode or the multicast mode is requested by the received live playing command. If the unicast mode is requested, Step 203 is performed; otherwise, Step 204 is performed.

Step 203: the playing terminal establishes a live communication connection with the media server, negotiates with the media server and sets up a live data transmission channel with the media server, and reports the live playing command to the media server through the established live communication connection. Upon receiving the live playing command, the media server forwards the data flows received from a video encoder to the playing terminal through the established live data transmission channel, and goes to Step 205.

Step 204: the playing terminal sends an Internet Group Management Protocol (IGMP) packet to the network to apply for joining to a multicast group to receive the live data flows transmitted by the video encoder in the multicast mode.

Step 205: upon receiving the live data flows, the playing terminal plays the received live data flows, and as such, switching from the live mode to the time-shift mode is implemented.

It can be seen from FIGS. 1 and 2 that, since the time-shift data flows are recorded by the media server and stored in a memory connected to the media server, the requirement of mass storage of the time-shift data flows can be satisfied.

However, in the above solutions, the live and the time-shift functions are implemented by using independent communication connections and data transmission channels. Therefore, when a switching between the live mode and the time-shift mode is needed, the playing terminal needs to release the established communication connection and the data transmission channel before establishing a new communication connection and a new data transmission channel according to the received switching command. As such, repeated operations of closing and establishing the communication connection and the data transmission channel between the playing terminal and the media server may result in low response speed of the time-shift operation.

### SUMMARY

The preferred embodiments of the present invention provide a method for implementing time-shift TV programs as well as devices and a system thereof to improve the response speed of time-shift operations.

The method in accordance with an embodiment of the present invention includes: establishing and holding a control channel between a playing terminal and a media server; transmitting a time-shift playing command to the media server by the playing terminal through the control channel; and upon receiving the time-shift playing command, the media server performing an operation corresponding to the time-shift playing command.

In another embodiment of the present invention, a playing terminal may include: a subscriber-side channel holding module, for establishing a control channel with a media server and periodically sending to the media server a message for holding the control channel; a command module, for transmitting a time-shift playing command to the media server through the control channel established by the subscriber-side channel holding module; a data flow receiving module, for receiving a time-shift data flow from the media server; and a playing module, for playing the time-shift data flow received by the data flow receiving module.

In another embodiment of the present invention, a media server may include: a network-side channel holding module, for establishing a control channel with a playing terminal, receiving a message for holding the control channel from the playing terminal, and holding the control channel; a command analyzing module, for receiving a time-shift playing command from the playing terminal, analyzing the time-shift playing command to determine a time-shift operation corresponding to the time-shift playing command, and controlling a command execution module to execute the time-shift operation; the command execution module, for performing the time-shift operation; and a data flow transmitting module, for transmitting a live data flow or a time-shift data flow to the playing terminal through the control channel according to an instruction of the command execution module.

In another embodiment of the present invention, a time-shift TV system may include a media server and a playing terminal. The media server and the playing terminal establish and hold a channel therebetween. The playing terminal sends a time-shift playing command to the media server through the channel; and the media server transmits a time-shift data flow or a live data flow to the playing terminal through the channel according to the time-shift playing command.

In an embodiment of the present invention, the time-shifted playing command is transmitted through a control transmission channel held all the time between the playing terminal and the media server, thus the existing communication connection and data transmission channel between the playing terminal and the media server are needn't removing and a new communication connection and a new data transmission channel are also needn't establishing. In this embodiment, the media server directly switches the live data flows to the time-shifted data flows or switches the time-shifted data flows to the live data flows through the established and held channel, increasing the speed of switchover between the live-play and the time-shifted playing and providing better service experiences to subscribers.

Due to such advantages as quick switchover implementation between the live-play and the time-shifted playing, higher switchover speed and better service experiences for subscribers, the present invention is good for spread and appliance of the time-shifted TV technique.

The control channel between the playing terminal and the media server is established based on a signalling interaction protocol according to an embodiment of the present invention, where the signalling interaction protocol may be a standard network transmission protocol or a network transmission protocol supported by both the playing terminal and the media server. Thus the solution of the present invention may be different in different scenes and has openness.

In an embodiment of the present invention, the control channel established and held between the playing terminal and the media server may be used to transmit both the switching commands and data flows to implement the interleaving of a signalling interaction channel with a data flow channel, thus the present invention has flexibility in system networking. Furthermore, since the switching command is transmitted through the established control channel both in the unicast application and in the multicast application according to an embodiment of the present invention, the design of the system is greatly simplified.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a flowchart illustrating a method of switching the live mode to the time-shift mode according to the prior art;

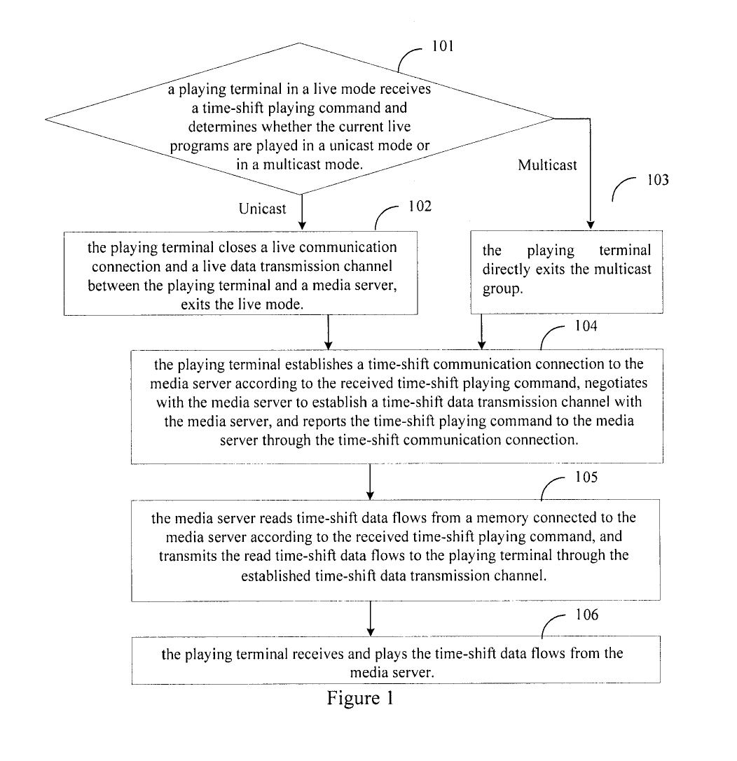

FIG. 2 is a flowchart illustrating a method of switching the time-shift mode to the live mode according to the prior art;

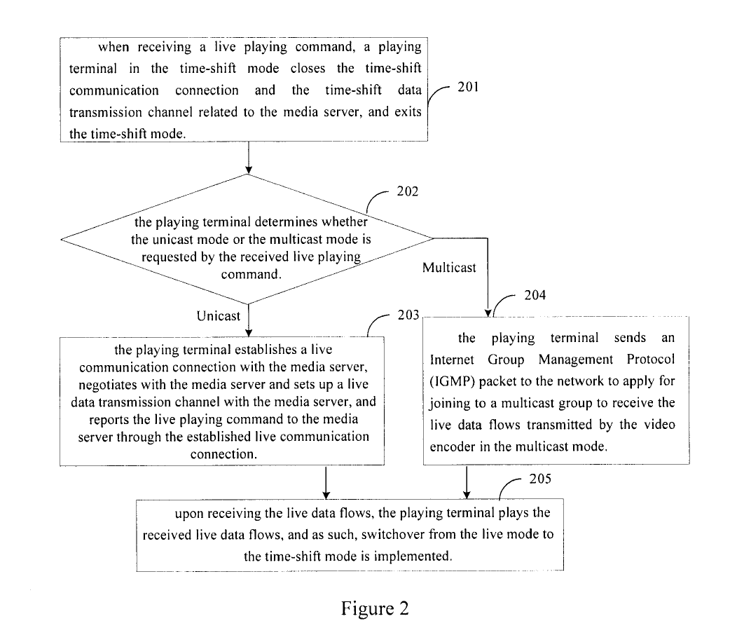

FIG. 3 is a flowchart illustrating the technical solution of implementing the time-shift playing in accordance with an embodiment of the present invention;

FIG. 4 is a flowchart illustrating the method of switching the live mode to the time-shift mode in accordance with embodiment 1 of the present invention;

FIG. 5 is a flowchart illustrating the method of switching the time-shift playing to a new time-shift playing in accordance with embodiment 2 of the present invention;

FIG. 6 is a schematic diagram illustrating the system connections in accordance with an embodiment of the present invention;

FIG. 7 is a schematic diagram illustrating the playing terminal in accordance with an embodiment of the present invention; and

FIG. 8 is a schematic diagram illustrating the structure of the media server in accordance with an embodiment of the present invention.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present invention is illustrated by way of examples, and not by way of limitation, in the figures of the accompanying drawings.

An embodiment of the present invention establishes and holds a control channel between the playing terminal and a media server, enabling the media server to receive a time-shift playing command from the playing terminal through the established control channel and to implement the corresponding time-shift operation according to the time-shift playing command.

The time-shift playing commands may include such modes as pause, fast scan reverse, fast scan forward, seeking and shortcut return. Table 1 shows the time-shift playing commands that may be executed by the playing terminal in various modes. The seeking refers to starting playing the time-shift data flows at a specified time. The shortcut return, as a special seeking playing, refers to switching the time-shift mode to the live mode without specifying a time because of the determined live presentation time.

TABLE 1

| mode before an | mode after an | | |
|---|---|---|---|
| execution of a | execution of a | | |
| time-shift | time-shift | | time-shift playing |
| playing | playing | | commands that may |
| command | command | Switching? | be executed |
| Live | Live | No | None |
| Live | Time-shift | Yes | Pause, fast scan |
| | | | reverse and seeking |
| Time-shift | Live | Yes | Fast scan forward, and |
| | | | seeking (shortcut |
| | | | return) |
| Time-shift | Time-shift | No | Pause, fast scan |
| | | | forward, fast scan |
| | | | reverse and seeking |

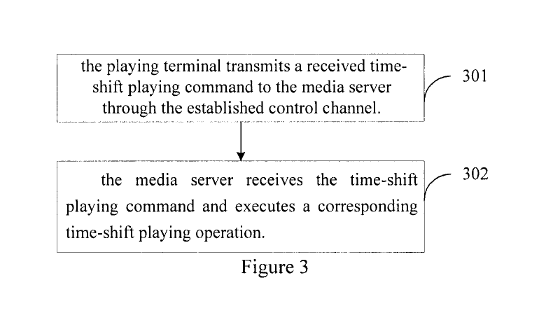

FIG. 3 shows a flowchart illustrating a technical solution for implementing the time-shift playing in accordance with an embodiment of the present invention. Before the solution is implemented, a control channel should be established and held between the playing terminal and the media server. The following steps will describe the solution in detail.

Step 301: the playing terminal transmits a received time-shift playing command to the media server through the established control channel. Those skilled in the art should understand that the time-shift playing command is usually initiated by a subscriber, but is not limited thereto.

Step 302: the media server receives the time-shift playing command and executes a corresponding time-shift playing operation.

Note that the control channel between the playing terminal and the media server is established based on a signalling interaction protocol. The signalling interaction protocol may be a standard network transfer protocol such as a Real Time Streaming Protocol (RTSP), or a network transfer protocol supported by both the playing terminal and the media server such as Hypertext Transfer Protocol (HTTP), or the Simple Object Access Protocol (SOAP) and so on. The control channel established and held between the playing terminal and the media server may be used to transmit both the switching commands and data flows, thereby enabling the switching between the data flows and the control streams.

The control channel between the playing terminal and the media server is held by adding a message of holding the control channel to the signalling interaction protocol. When the message of holding the control channel is added to the signalling interaction protocol, the playing terminal reports its state information to the media server periodically, while the media server cooperates with the playing terminal to hold the established control channel according to the state information of the playing terminal. For example, the playing terminal transmits an RTSP-based OPTION message to the media server periodically, and upon receiving the OPTION message, the media server won't release the established control channel if it detects that the playing terminal is still there according to the OPTION message.

If the playing terminal is in the live mode, such time-shift playing commands as pause, fast scan forward or seeking may be executed, and on contrary, if the playing terminal is in the time-shift mode, such time-shift playing commands as pause, fast scan forward, fast scan reverse or seeking may be executed.

The technical solutions for implementing a time-shift TV provided in the present invention will be described with preferred embodiments and drawings.

Embodiment 1 provides implementing process of a time-shift playing when the current mode is the live mode.

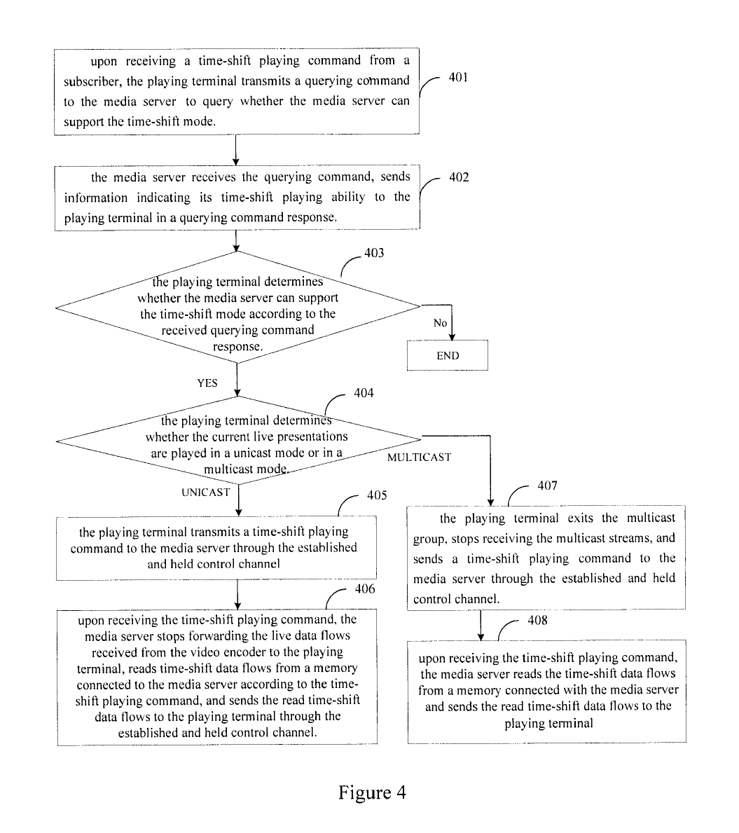

FIG. 4 shows a flowchart of switching a live mode to a time-shift mode in accordance with embodiment 1 of the present invention. In this embodiment, a control channel is pre-established and held between the playing terminal and the media server. The playing terminal is in the live mode, and the media server is transmitting live data flows received from a live source to the playing terminal. The live source may be a video encoder.

Step 401: upon receiving a time-shift playing command from a subscriber, the playing terminal transmits a querying command to the media server through the established and held control channel between the playing terminal and the media server to query whether the media server can support the time-shift mode.

Step 402: the media server receives the querying command, sends information indicating its time-shift playing ability to the playing terminal in a querying command response.

Step 403: the playing terminal determines whether the media server can support the time-shift mode according to the received querying command response. If the media server can support the time-shift mode, Step 404 may be performed.

Step 404: the playing terminal determines whether the current live presentations are played in a unicast mode or in a multicast mode. If the unicast mode is used, steps 405-406 are performed; otherwise, steps 407-408 are performed.

Step 405: the playing terminal transmits a time-shift playing command to the media server through the established and held control channel, where the time-shift playing command may be a pause command, a fast scan reverse command or a seeking command. When the time-shift playing command is the fast scan reverse command, the time-shift playing command may further include a speed of the fast scan reverse. Those skilled in the art should understand that the command may not include the speed of fast scan reverse and the media player may adopt a default speed of fast scan reverse. When the time-shift playing command is seeking, the command may further include a specified time which may be specified in various ways. For example, when the specified time is indicated in a time-difference mode, suppose the current time is 8 a.m. and the determined time difference is “−15 minutes”, the specified time is 7:45 a.m. When the specified time is indicated with absolute time, the specified time may be directly indicated by 7:45 a.m. Note that the specified time can be a certain time before the current time rather than a time after the current time.

Step 406: upon receiving the time-shift playing command, the media server stops forwarding the live data flows received from the video encoder to the playing terminal, reads time-shift data flows from a memory connected to the media server according to the time-shift playing command, and sends the read time-shift data flows to the playing terminal through the established and held control channel. As such, the live mode is switched to the time-shift mode.

When the time-shift playing command received by the media server is pause, step 406 may be specially described as follows.

Upon receiving the pause command, the media server stops forwarding the live data flows from the video encoder to the playing terminal and records the current time. The playing terminal stops decoding the live data flows and freezes the image at the current moment. The playing terminal does not play the data flows any more after pausing, thus what the media player should do is stopping transmitting the live data flows to the playing terminal.

When the time-shift playing command received by the media server is fast scan reverse, step 406 may be specially described as follows.

Upon receiving the fast scan reverse command, the media server stops forwarding the live data flows from the video encoder to the playing terminal, reads time-shift data flows from the memory connected to the media server according to a default speed of fast scan reverse or a speed specified in the fast scan reverse command, and sends the read time-shift data flows to the playing terminal through the established and held control channel according to the default speed or the speed of fast scan reverse. As such, the live mode is switched to the time-shift mode.

When the time-shift playing command received by the media server is a seeking command, step 406 may be specially described as follows.

Upon receiving the seeking command, the media server stops forwarding the live data flows from the video encoder to the playing terminal, reads the time-shift data flows from the memory connected to the media server according to the specified time in the seeking command, positions the start time of playing the time-shift data flows at the specified time, and sends the read time-shift data flows to the playing terminal through the established and held control channel. As such, the live mode is switched to the time-shift mode.

Step 407: the playing terminal exits the multicast group, stops receiving the multicast streams, and sends a time-shift playing command to the media server through the established and held control channel.

Step 408: upon receiving the time-shift playing command, the media server reads the time-shift data flows from a memory connected with the media server according to the time-shift playing command, and sends the read time-shift data flows to the playing terminal through the established and held control channel. As such, the live mode is switched to the time-shift mode. When the time-shift playing command is the pause command, the fast scan reverse command, or the seeking command, the special processes are identical to those of step 406, thus no more descriptions will be given here.

Embodiment 2 provides implementation of a new time-shift playing when the current mode is the time-shift mode. In the time-shift mode, such time-shift playing commands as pause, fast scan reverse, fast scan forward and seeking may be executed. The fast scan forward and seeking commands can switch the time-shift mode to the live mode in certain conditions. Additionally, for the sake of subscriber's convenience, a shortcut return command may be defined. The shortcut return command is a special seeking command where the specified time may be the current time, i.e. the play time of the live data flows.

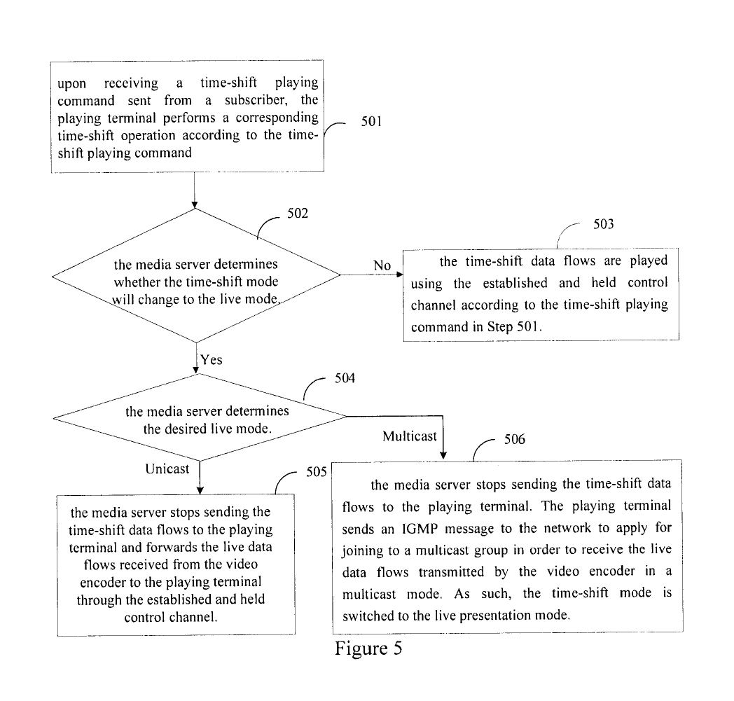

FIG. 5 shows a flowchart illustrating the implementation of the time-shift playing when the current mode is the time-shift mode in accordance with embodiment 2 of the present invention. In this embodiment, a control channel is pre-established and held between the playing terminal and the media server. The playing terminal is in the time-shift mode at the moment. The method may include these steps:

Step 501: upon receiving a time-shift playing command sent from a subscriber, the playing terminal performs a corresponding time-shift operation according to the time-shift playing command, that is, the playing terminal plays the corresponding time-shift data flows.

When the time-shift playing command is the pause command, the media server may stop transmitting the time-shift data flows to the playing terminal and may record the current time. The image on the playing terminal is frozen at the current playing time.

When the time-shift playing command is the fast scan reverse command, the media server starts transmitting the time-shift data flows recorded before the current played time-shift data flows to the playing terminal through the established and held control channel according to a default speed of fast scan reverse or a speed given by the fast scan reverse command.

When the time-shift playing command is the fast scan forward command, the media server starts transmitting the time-shift data flows recorded after the current played time-shift data flows, to the playing terminal through the established and held control channel according to a default speed of fast scan forward or a speed given by the fast scan forward command.

When the time-shift playing command is the seeking (shortcut return) command, the media server stops playing the time-shift data flows and positions the start time of playing the time-shift data flows at the time specified by the seeking command.

Step 502: the media server determines whether the time-shift mode will change to the live mode. If the time-shift mode will change to the live mode, perform Step 504; otherwise, perform Step 503. If the fast scan forward command is carried out currently, when the recorded time of the time-shift data flows played currently is the current time, the time-shift mode should be switched to the live mode. If the seeking command is carried out currently, when the specified time in the seeking command is the current time, the time-shift mode should be switched to the live mode.

Step 503: the time-shift data flows are played using the established and held control channel according to the time-shift playing command in Step 501.

In the case that the time-shift playing command is a seeking command, whether the time-shift mode will change to the live mode may be determined first. If the time-shift mode will not change to the live mode, the media server stops playing the time-shift flows, positions the start time of playing the new time-shift data flows at the specified time according to the time specified by the seeking command and plays the time-shift data flows. If the time-shift mode will change to the live mode, perform Step 504 directly.

Step 504: the media server determines the desired live mode. If a unicast mode is required, perform Step 505. If a multicast mode is required, perform Step 506.

If the time-shift playing command is the shortcut return command, Step 504 may be performed directly without performing Steps 501-503.

Step 505: the media server stops sending the time-shift data flows to the playing terminal and forwards the live data flows received from the video encoder to the playing terminal through the established and held control channel. As a result, the switching from the time-shift mode to the live mode is implemented.

Step 506: the media server stops sending the time-shift data flows to the playing terminal. The playing terminal sends an IGMP message to the network to apply for joining to a multicast group in order to receive the live data flows transmitted by the video encoder in a multicast mode. As such, the time-shift mode is switched to the live mode.

In Steps 406 and 408 of embodiment 1 of the present invention, the media server sends the read time-shift data flows to the playing terminal through the established and held control channel, implementing the time-shift playing. In embodiment 2 of the present invention, no matter whether the time-shift mode is switched to the live mode, the time-shift data flows are sent to the playing terminal through the established and held control channel. Moreover, when the time-shift mode is switched to the live mode, the live data flows are sent to the playing terminal through the control channel as well.

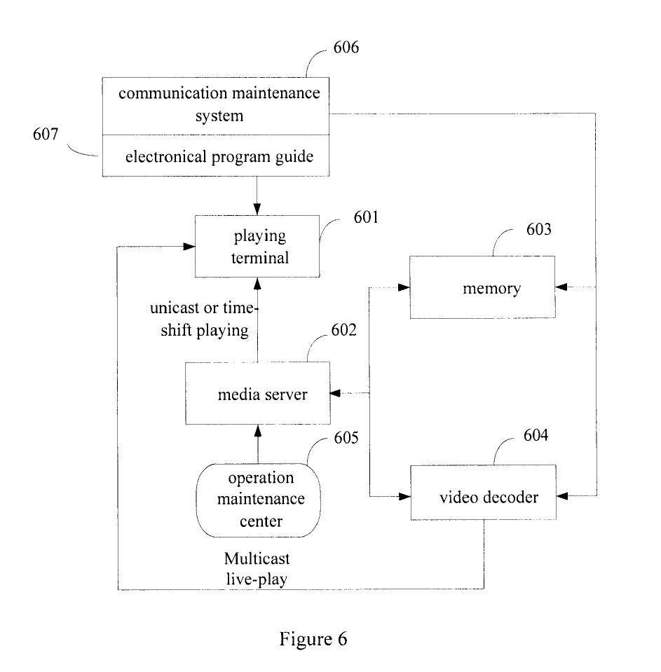

A time-shift system for implementing time-shift solution of the present invention is shown in FIG. 6, and includes a playing terminal 601, a media server 602, a memory 603 and a video decoder 604.

The playing terminal 601 is used for establishing and holding a control channel with the media server 602, sending a time-shift playing command to the media server 602 through the control channel, and receiving and playing time-shift data flows from the media server 602.

The media server 602 is used for establishing and holding the control channel with the playing terminal 601, receiving the time-shift playing command from the playing terminal 601 through the control channel, analyzing the time-shift playing command, reading the corresponding time-shift data flows and sending such time-shift data flows to the playing terminal 601. Moreover, the media server 602 is further used for sending the live data flows to the playing terminal 601 through the control channel and performing a switching between the live mode and the time-shift mode.

The memory 603 is utilized to record the live data flows to form a media file which is provided to the media server 602 to generate time-shift data flows. There may be multiple memories 603 in distributed design to record multiple channels simultaneously to satisfy the demand of mass storage.

The video decoder 604 is used for decoding the live data flows, transmitting the live data flows to the media server 602 and the memory 603, and also functions as a source of multicast programs.

The memory 603 and the video decoder 604 may be individually constructed or be integrated in the media server 602.

The system for implementing time-shift solution of the present invention may further include an operation maintenance center 605 maintaining the media server 602, a communication maintenance system 606 for maintaining the communication connections between each part of the whole time-shift system, and an electronic program guide 607 for notifying the playing terminal 601 of the contents of the live programs and facilitating to receive the live programs.

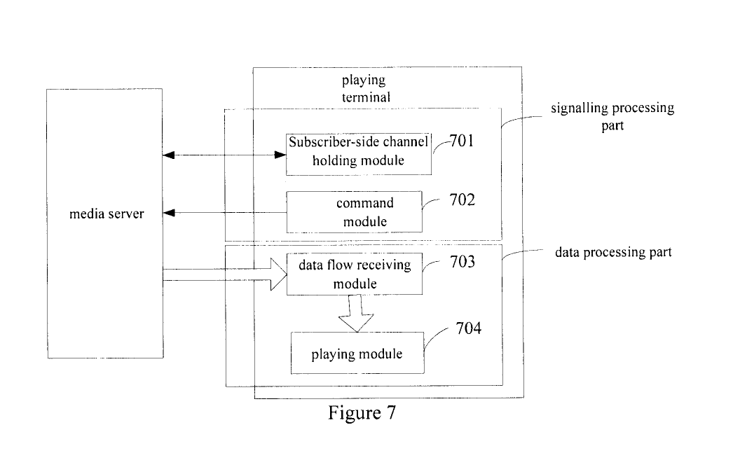

The playing terminal of the time-shift system of FIG. 6 is shown in FIG. 7, where the thick arrowhead denotes a data flow direction and the thin arrowhead denotes a signalling flow direction. The playing terminal may include a subscriber-side channel holding module 701, a command module 702, a data flow receiving module 703, and a playing module 704.

The subscriber-side channel holding module 701 is used to establish a control channel with the media server and periodically transmit a message to the media server to hold the control channel.

The command module 702 is used for transmitting a time-shift playing command to the media server through the control channel established by the subscriber-side channel holding module 701.

The data flow receiving module 703 is utilized to receive the time-shift data flows or the unicast data flows from the media server and receive the multicast data flows from the multicast source. The multicast source may be a media server or a video decoder.

The playing module 704 is utilized to play the received time-shift data flows, where the playing operations may include normal play, fast scan reverse, fast scan forward and pause. The playing module 704 is also used to play the received live data flows.

The subscriber-side channel holding module 701 and the command module 702 constitute a signalling processing part of the playing terminal, and the data flow receiving module 703 and the playing module 704 constitute a data processing part of the playing terminal.

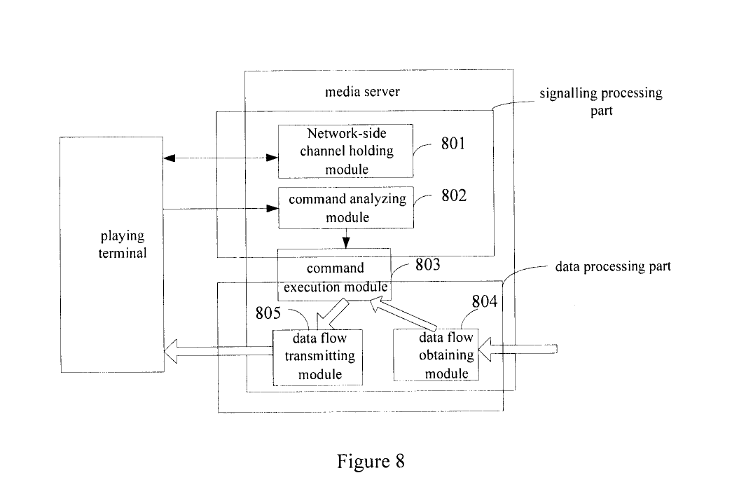

The media server of the time-shift system of FIG. 6 is shown in FIG. 8 where the thick arrowhead denotes a data flow direction and the thin arrowhead denotes a signalling flow direction. The media server may include a network-side channel holding module 801, a command analyzing module 802, a command execution module 803, a data flow obtaining module 804 and a data flow transmitting module 805.

The network-side channel holding module 801 is used for establishing a control channel with the playing terminal, receiving a message indicating to hold the control channel from the playing terminal, and holding the control channel.

The command analyzing module 802 is for use in receiving a time-shift playing command from the playing terminal, analyzing the contents of the time-shift playing command to determine the corresponding time-shift operation, and controlling the command execution module 803 to execute the time-shift operation.

The command execution module 803 is used for performing the time-shift operation. The time-shift operation may include at least one of recording the current time, i.e. the current time of playing the current live data flows, setting the time of playing the time-shift data flow, adjusting the speed of the time-shift data flows when the fast scan forward or fast scan reverse operation is executed, stopping or starting transmitting the time-shift data flows or the live data flows, and performing the interleaving of the time-shift data flows with the live data flows.

The data flow obtaining module 804 is used to receive the time-shift data flows from a memory or to receive the live data flows from a live program source. The live program source may be a video decoder.

The data flow transmitting module 805 is used to transmit the live data flows or the time-shift data flows through the control channel held between the media server and the playing terminal according to the command of the command execution module 803.

The network-side channel holding module 801 and the command analysis module 802 constitute a signalling processing part, while the data flow obtaining module 804 and the data flow transmitting module 805 constitute a data processing part. The command execution module 803 may be used both in executing signalling processing commands and in executing data processing commands.

In actual applications, the media server may also transmit the time-shift data flows to the playing terminal through the existing data transmission channel between the playing terminal and the playing terminal or through a newly-established data transmission channel to implement various time-shift operations such as a live-to-time-shift operation or a time-shift-to-live operation.

Though the present invention has been illustrated and described by some preferred embodiments, those skilled in the art should understand that various changes may be made in form and detail without departing from the spirit and the scope of the present invention and therefore should be covered in the protection scope of the present invention defined by the appended claims and its equivalents.

What is claimed is:

1. A method for implementing a time-shift television (TV), comprising:
establishing and holding a control channel between a playing terminal and a media server;
transmitting a time-shift playing command to the media server by the playing terminal through the control channel; and
upon receiving the time-shift playing command, the media server performing an operation corresponding to the time-shift playing command.

2. The method of claim 1, wherein the control channel between the playing terminal and the media server is established according to one of the Real Time Streaming Protocol (RTSP), the Hypertext Transfer Protocol (HTTP), and the Simple Object Access Protocol (SOAP).

3. The method of claim 1, wherein the playing terminal is in a live mode, and the method further comprising:
before transmitting the time-shift playing command to the media server, the playing terminal transmitting a querying command to the media server through the control channel to query whether the media server supports a time-shift mode; if the media server supports the time-shift mode, the playing terminal exiting the live mode and transmitting the time-shift playing command to the media server.

4. The method of claim 3, wherein the playing terminal exiting the live mode comprises:
if the playing terminal is in a unicast mode, the playing terminal stopping receiving a unicast data flow; if the playing terminal is in a multicast mode, the playing terminal exiting a multicast group and stopping receiving a multicast data flow.

5. The method of claim 3, wherein performing the operation corresponding to the time-shift playing command by the media server comprises:
if the time-shift playing command is a pause command, upon receiving the pause command, the media server stopping transmitting the live data flow to the playing terminal, and recording the current time.

6. The method of claim 3, wherein performing the operation corresponding to the time-shift playing command by the media server comprises:
if the time-shift playing command is a fast scan reverse command, the media server stopping transmitting the live data flow to the playing terminal, reading a time-shift data flow from a memory connected to the media server according to a default speed of the fast scan reverse or a speed specified in the fast scan reverse command, and sending the read time-shift data flow to the playing terminal through the control channel according to the default speed of the fast scan reverse or the speed specified in the fast scan reverse command.

7. The method of claim 3, wherein performing the operation corresponding to the time-shift playing command by the media server comprises:
if the time-shift playing command is a seeking command, the media server stopping transmitting the live data flow to the playing terminal, reading a time-shift data flow from the memory connected to the media server according to a specified time in the seeking command, positioning a start time of playing the read time-shift data flow at the specified time, and sending the read time-shift data flow to the playing terminal through the control channel.

8. The method of claim 1, wherein the playing terminal is in a time-shift mode, and performing the operation corresponding to the time-shift playing command comprises at least one of:
the media server stopping transmitting a time-shift data flow to the playing terminal, and recording a time of the current played time-shift data flow, when the time-shift playing command is a pause command;
the media server starting at a recorded time of the current played time-shift data flow to transmit a time-shift data flow to the playing terminal through the control channel according to a default speed of the fast scan reverse command/the fast scan forward command or a speed specified in the fast scan reverse command/the fast scan forward command, when the time-shift playing command is a fast scan reverse command/fast scan forward command; and
the media server stopping playing the time-shift data flow, positioning a start time of playing the time-shift data flow at a specified time which is specified in the seeking command, when the time-shift playing command is a seeking command.

9. The method of claim 8, further comprising:
the media server determining whether a time-shift mode is to change to a live mode; if the time-shift mode is to change to the live mode, the media server determining whether a unicast mode or a multicast mode to be used; and
if a unicast mode is used, the media server stopping sending the time-shift data flow to the playing terminal and forwarding the live data flow to the playing terminal through the established and held control channel; if a multicast mode is used, the media server stopping sending the time-shift data flow to the playing terminal, and the playing terminal transmitting an Internet Group Message Protocol (IGMP) message to apply for joining to a multicast group to receive the live data flow transmitted in the multicast mode.

10. A playing terminal, comprising:
a subscriber-side channel holding module, for establishing a control channel with a media server and periodically sending to the media server a message for holding the control channel;
a command module, for transmitting a time-shift playing command to the media server through the control channel established by the subscriber-side channel holding module;
a data flow receiving module, for receiving a time-shift data flow from the media server; and
a playing module, for playing the time-shift data flow received by the data flow receiving module.

11. The playing terminal of claim 10, wherein the playing module playing the time-shift data flow comprises one of:
playing the time-shift data flow in a normal play mode;
playing the time-shift data flow in a fast scan reverse mode;
playing the time-shift data flow in a fast scan forward mode;
playing the time-shift data flow in a pause mode; and
playing the time-shift data flow in a seeking mode.

12. The playing terminal of claim 10, wherein the data flow receiving module is further used for receiving the live data flow from a live program source; and the playing module is further used for playing the live data flow received by the data flow receiving module in a normal play mode.

13. A media server, comprising:
a network-side channel holding module, for establishing a control channel with a playing terminal, receiving a message for holding the control channel from the playing terminal, and holding the control channel;
a command analyzing module, for receiving a time-shift playing command from the playing terminal, analyzing the time-shift playing command to determine a time-shift operation corresponding to the time-shift playing command, and controlling a command execution module to execute the time-shift operation;
the command execution module, for performing the time-shift operation; and
a data flow transmitting module, for transmitting a live data flow or a time-shift data flow to the playing terminal through the control channel according to an instruction of the command execution module.

14. The media server of claim 13, wherein the time-shift operation performed by the command execution module comprises at least one of:
an operation of recording the time of the current live data flow;
an operation of adjusting a time of playing the time-shift data flow;
an operation of adjusting a speed of fast scan forward or a speed of fast scan reverse of the time-shift data flow;
an operation of stopping or starting transmitting the time-shift data flow or the live data flow; and
an operation of performing interleaving the time-shift data flow with the live data flow.

15. The media server of claim 13, further comprising one of:
a data flow obtaining module, for performing one of receiving the time-shift data flow from a memory and receiving the live data flow from a program source;
a video decoder functioning as a live program source; and
a memory for storing the live data flow as a media file.

16. A time-shift TV system, comprising:
a media server and a playing terminal;
wherein the media server and the playing terminal establish and hold a channel therebetween; the playing terminal sends a time-shift playing command to the media server through the channel; and the media server transmits a time-shift data flow or a live data flow to the playing terminal through the channel according to the time-shift playing command.

17. The time-shift TV system of claim 16, further comprising:
a video decoder functioning as a live program source;
wherein the media server transmitting the live data flow to the playing terminal comprises:
the media server receiving a live data flow from the video decoder and forwarding the received live data flow to the playing terminal.

18. The time-shift TV system of claim 17, further comprising:
a memory for storing the live data flow as a media file;
wherein the media transmitting the time-shift data flow to the playing terminal comprises:
the media server reading the media file in the memory to form a time-shift data flow and transmitting the time-shift data flow to the playing terminal.

19. The time-shift TV system of claim 17, wherein the video decoder or the memory is integrated in the media server.
